(19) United States
(12) Patent Application Publication
(10) Pub. No.: US 2022/0311775 A1
(43) Pub. Date: Sep. 29, 2022

(54) BEHAVIOR-BASED ACCESS CONTROL MANAGEMENT FOR APPLICATION SOFTWARE OF COMPUTING DEVICES

(71) Applicant: Rowan University, Glassboro (US)

(72) Inventor: Bethany R. Raiff, Collingswood, NJ (US)

(21) Appl. No.: 17/706,114

(22) Filed: Mar. 28, 2022

Related U.S. Application Data
(60) Provisional application No. 63/166,647, filed on Mar. 26, 2021.

(51) Int. Cl. H04L 9/40

(52) U.S. Cl. CPC H04L 63/102; H04L 63/0853

(57) ABSTRACT

A computerized system and method providing a user interface for management of access to software applications and/or other computing device resources to achieve desired behavioral changes by using sensor-based hardware to assess behavioral aspects and selectively grant or deny desired access based on sensor-gathered data in comparison to predetermined behavior goals. In part, the present invention captures an opportunity to use access to desired mobile computing device apps (or other computing resources) as a low-cost, non-monetary incentive for beneficial behavior modification purposes, such as smoking cessation, etc.

### CROSS-REFERENCE TO RELATED APPLICATION

This application claims the benefit of U.S. Provisional Patent Application No. 63/166,647, filed Mar. 26, 2021, the entire disclosure of which is hereby incorporated herein by reference.

### FIELD OF THE INVENTION

The present invention relates generally to mobile computing devices, and more specifically, to a computerized system and method having a graphical user interface for managing access to software applications or other computer resources on computing devices using a sensor/device for capturing behavioral information, so that sensor-verified data of desired behavior is required to obtained desired access to the software/computer resource.

### DISCUSSION OF RELATED ART

There is generally a need for security and access control for computing devices, including mobile computing devices such as smartphones, tablet computers, etc., as well as for personal computing devices such as desktop personal computers (PCs), laptop/notebook computers, and the like. There is currently a broad range of security measures implemented for computing devices. For example, access to the operating system, software applications, functionality and/or other resources of a smartphone device or a personal computer may be password-protected, such that a person needs to provide a pre-determined password to gain access to the computer resources, and such that access will be provided (e.g., the computing device will be “unlocked”) only if an expected/approved/suitable password is provided. Two-factor authentication systems often involve not only a password, but also an access code sent at the time of an access request, and those access codes may be delivered via a smartphone or other computing device, an electronic “fob” or other hardware. Access to individual software applications of a computer system may similarly be secured, and require a suitable password, access code, etc.

Further, some computing devices may be secured by sensor hardware designed to gather unique biometric information, e.g., via a retinal scan or a fingerprint scan, to otherwise confirm that the person attempting access is in fact an approved/authorized person with suitable credentials.

In these cases, however, the security measures are generally designed to limit access to computers and their software to only those persons that are authorized to have such access.

Further, it is noted that people are increasingly engaged with computing devices, and particularly with smartphone and similar types of computing devices not only for work/business purposes, but also for personal and recreational purposes. For example, it has been estimated that approximately 81% of U.S. adults own a smartphone and 90% of the time people spend on their smartphones involves using mobile software applications (“apps”). In an exemplary survey, 96% of people reported that they use messaging apps, 81% used mobile games apps, 70% used social networking apps, 47% used retail apps, and 40% used their mobile phones to read the news. Further still, it has been noted that many people have behaviors that they wish to decrease, such as smoking, vaping, alcohol and/or cannabis consumption, etc., and/or increase, such as exercise, weight loss, medication regimen adherence, homework completion, chore completion, etc. for medical, health and wellness, or other purposes.

What is needed is a system and method providing a user interface for management of access to computing device resources that can help to achieve desired changes in behavior.

### SUMMARY

The present invention provides a computerized system and method providing a user interface for management of access to computing device resources that can help to achieve desired changes in behavior, by using sensor-based hardware to assess aspects of behavior and to selectively grant or deny desired access to computing device resources based on sensor-gathered data, e.g., in comparison to predetermined behavior goals. In this manner, for example, the access control measures limit access to computing device resources not based solely on the identity of a person (e.g., a person that is authorized to have such access), but rather based on the behavior of a person (as captured objectively by a sensor), e.g., in relation to predetermined behavior goals.

In part, the present invention captures an opportunity to use access to desired mobile computing device apps as a low-cost, non-monetary incentive for beneficial behavior modification purposes.

### BRIEF DESCRIPTION OF THE FIGURES

For a better understanding of the present invention, reference may be made to the accompanying drawings in which:

FIG. 1 is a system diagram showing an exemplary network computing environment in which the present invention may be employed;

FIG. 2 is a schematic diagram of an exemplary special-purpose Access Management System computing device in accordance with an exemplary embodiment of the present invention; and

FIG. 3 is a flow diagram illustrating an exemplary method for behavior-based access control management for a computer resource of computing devices in accordance with an exemplary embodiment of the present invention;

FIG. 4 is a flow diagram illustrating an exemplary method for sensor-verified earning of tokens as part of behavior-based access control management for a computer resource of computing devices in accordance with an alternative exemplary embodiment of the present invention; and

FIG. 5 is a flow diagram illustrating an exemplary method for token-based behavior-based access control management for a computer resource of computing devices in accordance with an exemplary embodiment of the present invention;

FIGS. 6-9 show exemplary graphical user interface windows for behavior-based access control management for a computer resource in accordance with the present invention.

### DETAILED DESCRIPTION

According to illustrative embodiment(s) of the present invention, like reference numerals are used consistently throughout to refer to like and corresponding parts of the invention for all of the various views and figures of the drawings.

The following detailed description of the invention contains many specifics for the purpose of illustration. Any one of ordinary skill in the art will appreciate that many variations and alterations to the following details are within scope of the invention. Accordingly, the following implementations of the invention are set forth without any loss of generality to, and without imposing limitations upon, the claimed invention.

### System Environment

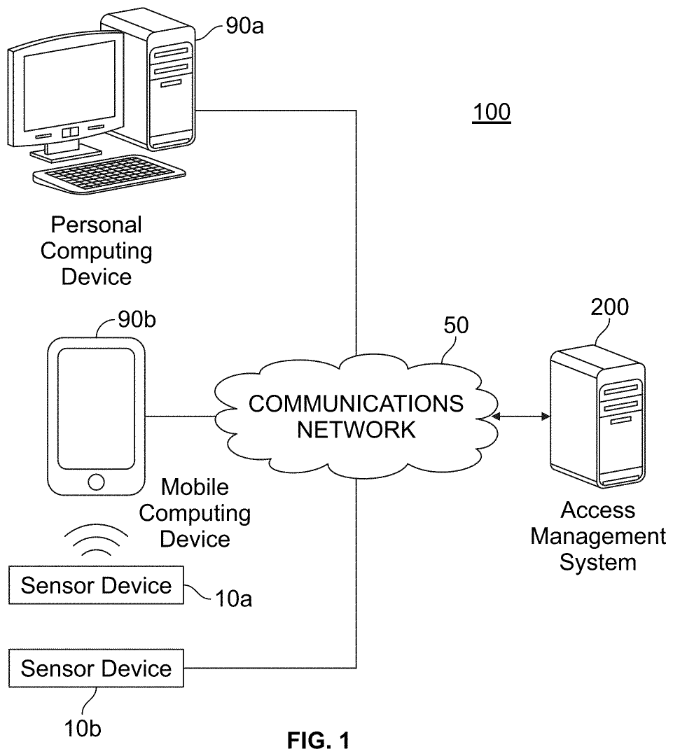

An exemplary embodiment of the present invention is discussed below for illustrative purposes. FIG. 1 is a system diagram showing an exemplary network computing environment 100 in which the present invention may be employed. As shown in FIG. 1, the exemplary network environment 100 includes conventional computing hardware and software for communicating via a communications network 50, such as the Internet, etc., using Computing Devices 90a, 90b, which may be, for example, one or more personal computers/PCs, laptop computers, tablet computers, smartphones, or other computing device hardware.

In accordance with a certain aspect of the present invention, one or more of the Computing Devices 90a, 90b may store and execute an “app” or other purpose-specific application software in accordance with the present invention, although this is not required in all embodiments.

In accordance with the present invention, the exemplary network computing environment 100 further includes at least on Sensor Device 10a, 10b. The

Sensor Device may be, or may include, any suitable sensor for measuring/recording behavior of a person and/or the person's activities in relation to any desired behavior. Various conventional and suitable sensors are commercially available. For example, suitable hardware sensors may be, or may be incorporated into, a scale for measuring a person's weight, a camera for capturing still images or recording video images, a wearable activity tracker such as a Fitbit or Apple Watch, a breathalyzer or breath analysis test for measuring a blood alcohol level associated with alcohol drinking, a carbon monoxide detector for measuring a carbon monoxide level associated with smoking, an electronic pill dispenser, etc. Alternatively, the Sensor Device (which is shown separately for illustrative purposes only in FIG. 1), may be incorporated into the Computing Device 90a, 90b, such as a hardware accelerometer of such a computing device, or a software that monitors certain behaviors performed on the computing device hardware. Any suitable sensor may be used, according to the behavior desired to be monitored. In the exemplary embodiment of FIG. 1, Sensor Device 10b is configured for data communication via the network 50, and Sensor Device 10a is configured for data communication directly with a Computing Device 90a, 90b, via direct data communication, e.g., via a Bluetooth or other short range wireless communication, via near-field communication (NFC) or other convention communication technique, without transmitting data via the network 50.

In accordance with the present invention, the exemplary network computing environment 100 further includes an Access Management System (AMS) 200. In this exemplary embodiment, the AMS 200 is operatively connected to the Computing Devices 90a, 90b and the Sensor Device 10b for data communication via the communications network 50. For example, the AMS 200 may gather user data or other inputs from each device 90a, 90b, as well as generated data generated by the Sensor Device 10b by data communication via the communications network 50. Hardware and software for enabling communication of data by such devices via such communications networks are well known in the art and beyond the scope of the present invention, and thus are not discussed in detail herein.

By way of example, the present invention may be implemented to perform a gatekeeper function for access to computer resources, such as a smartphone “app” or other application software, of the Computing Devices 90a, 90b, whether the gatekeeper function is provided at least in part by software at a remotely located AMS as shown in the example of FIG. 1, or solely by software stored on the Computing Device 90a, 90b. The gatekeeper function selectively grants or denies access to desired computing device resources (such as one or more application software programs) based on sensor-gathered data, e.g., in comparison to predetermined behavior goals. More particularly, desired access to computing device resources (such as favorite social media or other application software programs) is permitted only after a sensor device gathers data from a person confirming that the person's recent behavior (e.g., smoking abstinence) has been consistent with selected behavior goals (e.g., smoking cessation). In this manner, for example, the access control measures limit access to computing devices resources not based solely on the identity of a person (e.g., a person that is authorized to have such access), but rather based on the behavior of the person (as captured by a sensor), e.g., in relation to predetermined behavior goals.

### Access Management System

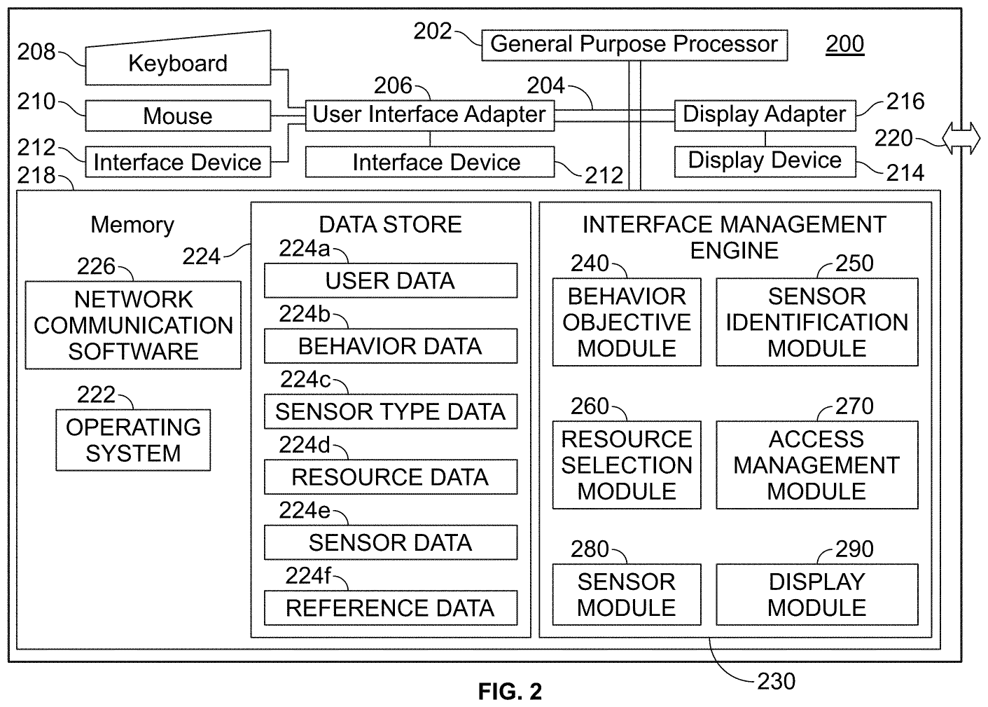

FIG. 2 is a block diagram showing an exemplary Access Management System (AMS) 200 in accordance with an exemplary embodiment of the present invention. The AMS 200 is a special-purpose computer system that includes conventional computing hardware storing and executing both conventional software enabling operation of a general purpose computing system, such as operating system software 222, network communications software 226, and specially-configured computer software for configuring the general purpose hardware as a special-purpose computer system for carrying out at least one method in accordance with the present invention. By way of example, the communications software 226 may include conventional web server software, and the operating system software 22 may include iOS, Android, Windows, Linux software.

In this exemplary embodiment, the AMS 200 includes the system components providing the gatekeeper functionality, but in other embodiments, the user's Personal Computing Device 90a or Mobile Computing Device 90b may be configured with the gatekeeper functionality of the AMS 200 and some or all of the components shown in FIG. 2.

Accordingly, the exemplary AMS 200 of FIG. 2 includes a general-purpose processor, such as a microprocessor (CPU), 102 and a bus 204 employed to connect and enable communication between the processor 202 and the components of the presentation system in accordance with known techniques. The exemplary presentation system 200 includes a user interface adapter 206, which connects the processor 202 via the bus 204 to one or more interface devices, such as a keyboard 208, mouse 210, and/or other interface devices 212, which can be any user interface device, such as a camera, microphone, touch sensitive screen, digitized entry pad, etc. The bus 204 also connects a display device 214, such as an LCD screen or monitor, to the processor 202 via a display adapter 216. The bus 204 also connects the processor 202 to memory 218, which can include a hard drive, diskette drive, tape drive, etc.

The AMS 200 may communicate with other computers or networks of computers, for example via a communications channel, network card or modem 220. The AMS 200 may be associated with such other computers in a local area network (LAN) or a wide area network (WAN), and may operate as a server in a client/server arrangement with another computer, etc. Such configurations, as well as the appropriate communications hardware and software, are known in the art.

The AMS 200 is specially-configured in accordance with the present invention. Accordingly, as shown in FIG. 2, the AMS 200 includes computer-readable, processor-executable instructions stored in the memory 218 for carrying out the methods described herein. Further, the memory 218 stores certain data, e.g. in one or more databases or other data stores 224 shown logically in FIG. 2 for illustrative purposes, without regard to any particular embodiment in one or more hardware or software components.

Further, as will be noted from FIG. 2, the AMS 200 includes, in accordance with the present invention, an Interface Management Engine (IME) 230, shown schematically as stored in the memory 218, which includes a number of additional modules providing functionality in accordance with the present invention, as discussed in greater detail below. These modules may be implemented primarily by specially-configured software including microprocessor—executable instructions stored in the memory 218 of the AMS 200. Optionally, other software may be stored in the memory 218 and and/or other data may be stored in the data store 224 or memory 218.

As shown in FIG. 2, the exemplary embodiment of the AMS 200 also includes a Behavior Objective Module (BOM) 240. The BOM 240 is responsible for causing display of one or more graphical user interface windows at a Computing Device 90a, 90b for gathering user account information, and a user's identification of a behavior modification objective, such as smoking, vaping, alcohol and/or cannabis consumption cessation, or increased/improved exercise, weight loss, medication regimen adherence, homework completion, chore completion, etc. In certain embodiments, this involves causing transmission of data via the network to cause display of graphical user interface windows at a Computing Device 90a, 90b for receiving/gathering such information and causing it to be stored in the data store 224 of the AMS 200 as User Data 224a. This may involve displaying a list of user-selectable behavior modification objectives, by retrieving associated data stored as Behavior Data 224b in the data store 224, providing a list of behavior objectives.

In accordance with the present invention, the exemplary embodiment of the AMS 200 shown in FIG. 2 also includes a Sensor Identification Module (SIM) 250. The SIM 250 is responsible for identifying a suitable sensor for use in conjunction with the identified behavior objective. This may involve reference to Sensor Type Data 224c stored in the Data Store 224 of the AMS 200. The Sensor Type Data 224c may identify types, and optionally specific brands/models, of suitable sensor types in associated with each of a plurality of behavior objectives. For example, for a smoking cessation behavior objective, the Sensor Type Data 224c may identify one or more carbon monoxide detectors as suitable, for an alcohol abstinence objective, the Sensor Type Data 224c may identify one or more breath analysis devices as suitable, and for a weight loss objective, the Sensor Type Data 224c may identify one or more electronic/digital scales as suitable. This may further involve causing display of graphical user interface windows at a Computing Device 90a, 90b for displaying the list of suitable sensor types and devices received from the Sensor Type Data 224c, for a given behavior objective, and receiving a user's input of a selection of a corresponding sensor type and/or device. The particular sensor type and device to be used for the user in connection with the user's behavior objective may be stored as User Data 224a in association with an identification of the user. In certain embodiments, the SIM 250 may not have all of this functionality and may, for example, be simply hard-coded to a particular sensor selection and/or device.

In accordance with the present invention, the exemplary embodiment of the AMS 200 shown in FIG. 2 also includes a Resource Selection Module (RSM) 260. The RSM 260 is responsible for identifying particular computer resources to which access will be selectively permitted or denied, based on the user's behavior, and more particularly, on the sensor's objective capture of data relating to the user's behavior. This may involve transmitting data via the network 50 to cause display of graphical user interface windows at one or more Computing Device 90a, 90b for gathering a user's identification of computer resources to be subjected to this conditional access. For example, a user may choose to incentive desired behavior by the user by limiting the user's access to a particular computer resource that the user regularly wishes to access, such as a preferred social media smartphone app, etc.

In certain embodiments, the RSM 260 is configured to programmatically identify a particular computer resource to be subjected to this conditional access. By way of example, the RSM 260 may be configured to choose different computer resources over time, on a rotating basis, or to choose one randomly, or to choose one according to predetermined logic. In other embodiments, the RSM 260 is configured to track the past usage of and/or currently running computer resources (e.g., apps) and to identify a set of more frequently used computer resources. This informs the RSM 260 as to which apps/computer resources are candidates for behavior-based access controls. Further, the RSM 260 is configured to display a list of the more frequently used computer resources via a display device of the user's Computing Device and to permit the user to select from the displayed list (by providing input to the computing device) a specific computer resource to which the gatekeeper/conditional access functionality will be applied, so that the user's selected computer resource will be subjected to the behavior-based conditional access controls. For example, a user that likes to frequently use a particularly social media app may choose that app to be access-controlled by the gatekeeper/conditional access functionality consistent with the present invention, such that the user will be incentivized to maintain a desired behavior so that readings confirming the desired behavior can be recorded by the relevant sensor to unlock access to the social media app. Accordingly, the user's desire for the app can be used as a driver to help the user in making desired behavioral modifications. The RSM 260 in conjunction with the Display Module 290 may cause display of windows requiring the user to take actions and provide inputs to the operating system software via the graphical user interface to grant permissions necessary to implement the blocking functionality, according to the particular implementation for a particular computing device.

In certain embodiments, the RSM 260 may be configured to include or exclude certain computer resources from a list of user-selectable computer resources, e.g., based on the criticality of access to the resource, e.g., to exclude a particular resource from eligibility for access controls if it is deemed important for the user to have access to that resource at all times. For example, the RSM 260 may be configured to never subject an important and/or safety-related computer resource to be subjected to such conditional access, but may permit non-essentially/recreational computer resources to be subjected to such conditional access. After a particular computer resource, or parameters for selecting a computer resource, have been identified, those selections/parameters may be stored as Resource Data 224d in the Data Store 224. These selections may vary on a per-user basis, and may vary over time for a single user, and may be reflected in the Resource Data 224d and/or in the User Data 224a.

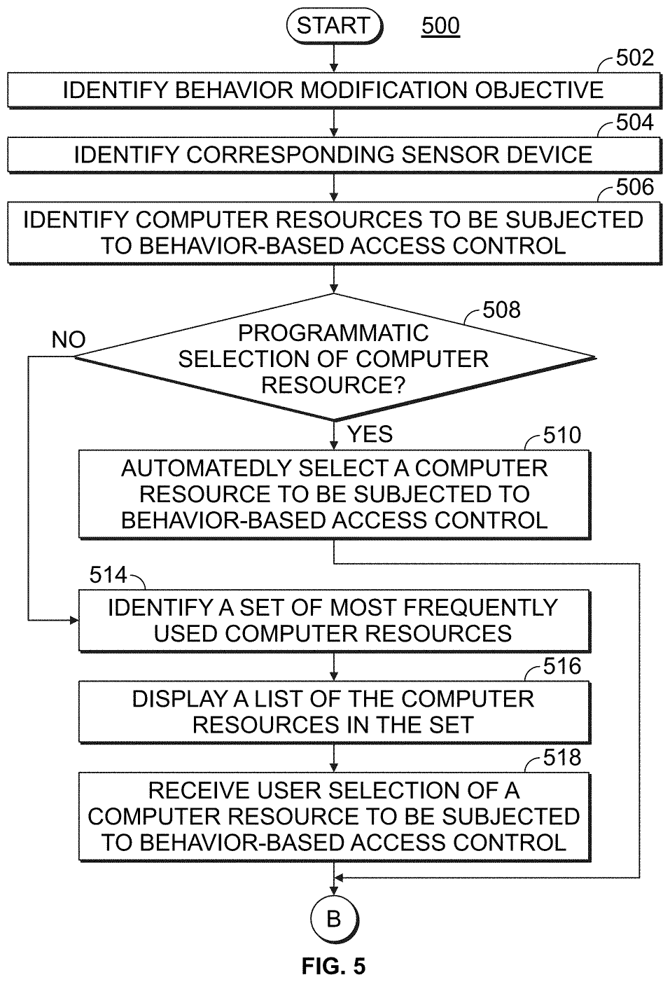

FIG. 6 shows an exemplary graphical user interface window 600 displayed by the AMS 200 (e.g., by RSM 260 acting in concert with the Display Module 290) on the user's Computing Device, such as Mobile Computing Device 90b in the example shown in FIG. 6. As will be appreciated from FIG. 6, window 600 includes a Resource Status panel 610 displaying a list of multiple app-type computer resources that have been designated (e.g., by the user or by selection by the RSM 260) to be locked, and thus subject to behavior-based access controls in accordance with the present invention.

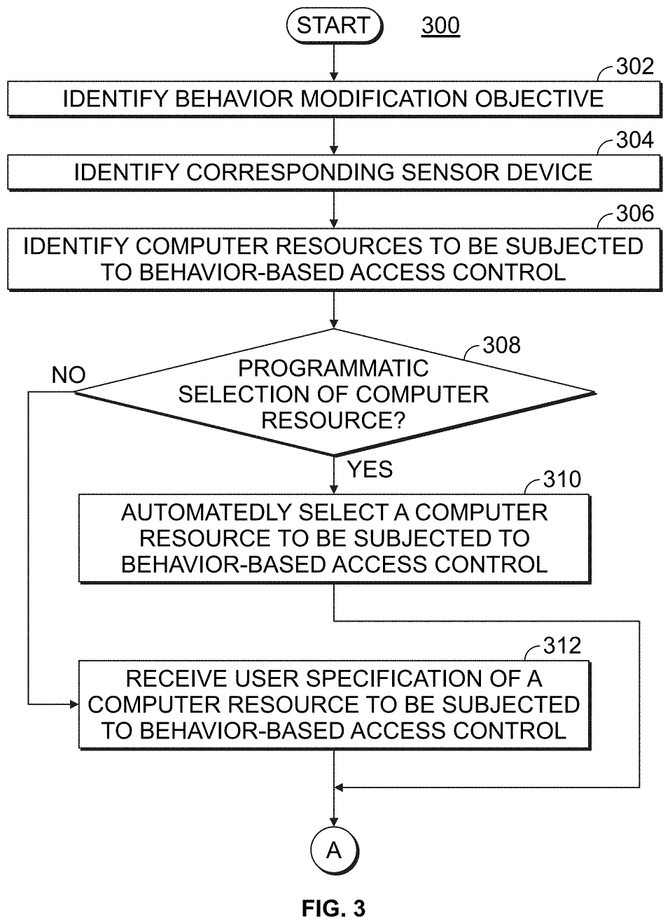

In accordance with the present invention, the exemplary embodiment of the AMS 200 shown in FIG. 2 also includes an Access Management Module (AMM) 270. The AMM 270 is responsible for receiving requests to access a computer resource, determining if it's a resource subject to conditional access, gathering data via the suitable sensor device, for the user's behavior objective, comparing the gathered behavior data gathered via the suitable sensor device to reference data indicative of acceptable/unacceptable behavior (by reference to Reference Data 224f stored in the data store), and selectively permitting or denying access to the computer resources, in response to the request, as a function of whether or not the sensor-gathered data indicates behavior that is, or is not, consistent with the user's behavior objective. The Reference Data may include data particular to a specific user, such as a particular user's desired weight as detectable by a scale, or may include general parameters suitable for use across multiple users, such as a blood alcohol level as detectable by a breath analysis sensor. Such an embodiment is discussed below with reference to FIG. 3.

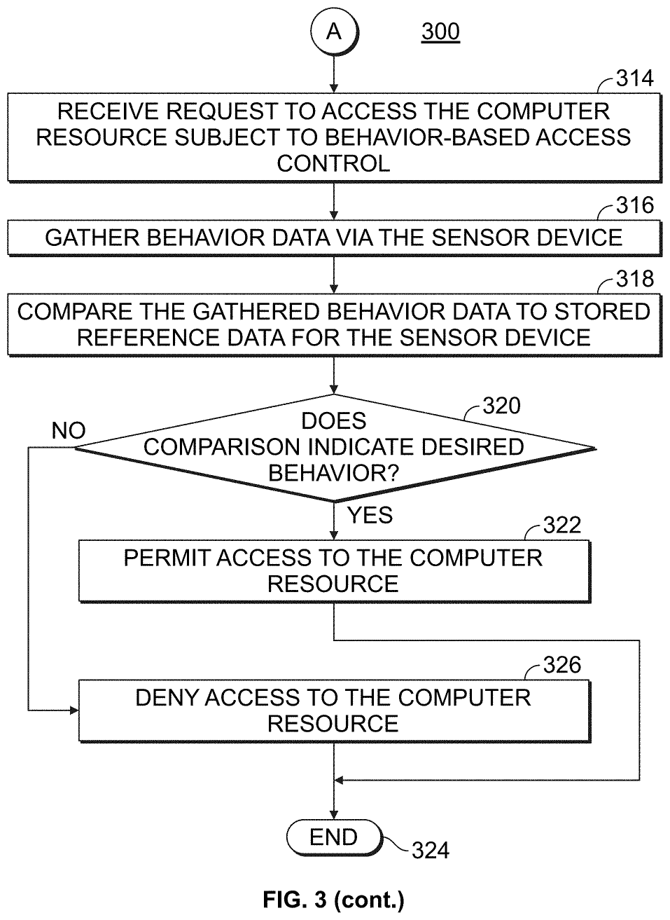

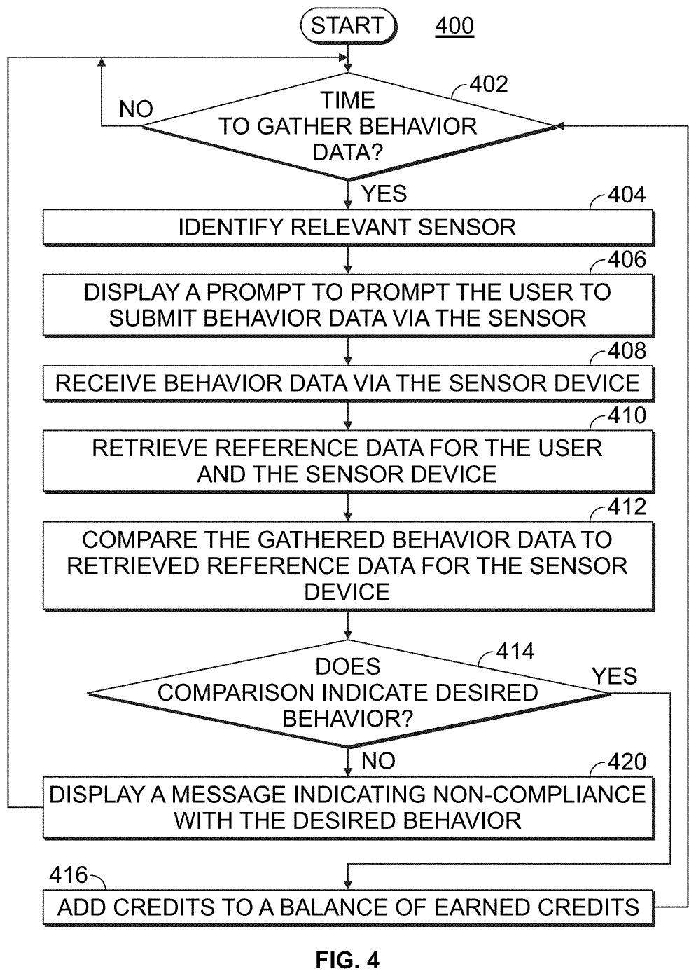

In certain embodiments, it is desirable to gather behavior data via the sensor at regular or prescribed intervals, and to allow conditional access of computer resources at any time. In such embodiments the AMM 270 determines when it is time to gather behavior data, determines which sensor is relevant if needed, and prompts the Sensor Module 280 to gather relevant data via the relevant sensor. Further, in addition to comparing the gathered behavior data to the reference data, the AMM 270 determines whether the comparison indicates the desired behavior as a function of whether or not the sensor-gathered data indicates behavior that is, or is not, consistent with the user's behavior objective. Further still, as part of selectively permitting or denying access to the computer resources, the AMM 270 stores a balance of earned tokens for the user (e.g., stored as User Data 224a) and adds tokens to the balance (according to any desired logic) when the gathered behavior data from the sensor is determined to show that the user's behavior is consistent with the user's behavior objective. Optionally, the AMM 270 may cause display of a message indicating non-compliance with the behavior objective in the event that the gathered behavior data from the sensor is determined not to show that the user's behavior is consistent with the user's behavior objective. Subsequently, in response to a request to access a computer resource subject to behavior-based access control, the AMM 270 blocks the user's access to the computer resource until after sufficient earned tokens have been tendered (such that the user's behavior consistent with the behavior objective and observed/captured by the sensor has earned the user the ability to access the computer resource subject to the behavior-based access control). The AMM 270 denies access to the computer resource if the user attempt to tender the tokens, or does not have sufficient tokens to “purchase” access. The AMM 270 permits access to the computer resource if the user attempts to tender the tokens and has sufficient tokens to “purchase” access, and subtracts the tendered tokens from a token balance. Preferably, access is permitted for only a limited period of time (e.g., a single session, a few hours, a day, etc.) after which access is no longer permitted as part of the initial access “purchase.” This provides a continuing incentive for the user to continue the desired behavior over time, to be able to continue to access the access-controlled resource over time. In certain embodiments, earned tokens may be subtracted (according to any desired logic) from the token balance over time, to prevent the user from “banking” so many tokens that user is disincentivized to continue the desired behavior. Such an embodiment is discussed below with reference to FIGS. 4 and 5.

Any suitable approach may be provided to implement the functionality of the AMM 270, and the approaches may vary depending upon the computing device, operating system and/or environment in which the AMM 270 is operated. Similarly, the AMM 270 is configured to discontinue its blocking of access to the computer resource when it detects that sufficient tokens have been tendered.

In accordance with the present invention, the exemplary embodiment of the AMS 200 shown in FIG. 2 also includes a Sensor Module (SM) 280. The SM 280 is responsible for gathering data via the suitable sensor device (e.g., working in concert with the AMM 270). This may involve, for example, referencing the User Data, Behavior Data and/or Sensor Type Data, and transmission data via the network or otherwise causing display via the Computing Device 90a, 90b to prompt the user to provide input via the suitable sensor. This may include, for example, display of an instruction to provide a breath sample via a breath analysis device, or to weigh oneself via scale, etc. Data gathered via the sensor may be stored as Sensor Data 224e in the Data Store 224.

In accordance with the present invention, the exemplary embodiment of the AMS 200 shown in FIG. 2 also includes a Display Module (SM) 290. The DM 290 is responsible for acting in concert with one or more other modules of the Interface Management Engine 230 to cause display on a user's Computing Device 90a, 90b of graphical user interface windows for displaying information and/or prompting and/or receiving user input in support of the functionality described herein. Referring again to FIG. 6, the exemplary graphical user interface window 600 displayed by the AMS 200 (e.g., by the Display Module 290) on the user's Computing Device, includes a panel 620 displaying a representation (e.g., graphical depiction) or the user's past performance relative to the behavior objective, e.g., in the form of a display of data gathered via the sensor for a recent time period. In this exemplary embodiment, the graphical user interface window 600 further includes a user-selectable button 630 for initiating a gathering and/or submission of data using the associated sensor, as well as a Token Balance panel 640 displaying a balance of tokens, e.g., tokens earned as a result of past collection of behavior data via the sensor that indicate behavior objective-compliant behavior, available for “purchase” of access to a computer resource in accordance with the present invention, as discussed in greater detail below.

With respect to the description of the exemplary embodiment above, it should be further noted that in certain other embodiments, some the functions described above may be omitted, and instead of providing a user with choices of behavior modification objective, sensor type, resource to be controlled, etc. those parameters may be hard-coded into the application software, such that there is no need to gather input from a user. For example, a certain application may be dedicated to a single behavior modification objective. Also, in other embodiments, the various components and/or functionality of the IME 230 described above may be incorporated into a software application at the Computing Device 90a, 90b, such that there is a reduced need or no need for involvement of a remotely-located AMS 200 to gather such information. Rather, these functions may be managed partly or solely at the Computing Device 90a, 90b, by software at the Computing Device.

FIG. 3 is a flow diagram 300 illustrating an exemplary method for behavior-based access control management for application software (or other computer resources) of computing devices. Referring now to FIG. 3, the exemplary method begins with identification of a behavior modification objective, as shown at 302. As described above, this may be performed by the BOM 240, and may involve causing display (by transmission of data via the network 50 by the AMS 200, or by software resident at the Computing Device 90a, 90b) at the computing Device 90a, 90b of a graphical user interface allowing a user to select a behavior modification objective from a displayed list of behavior modification objectives.

Next, the method involves identification of a suitable sensor device corresponding to the behavior modification objectives, as shown at 304. As described above, this may be performed by the SIM 250, and may be performed according to a user's selection of a particular sensor device, or may be based upon the user's selection of a behavior modification objective, or may be done automatedly/programmatically.

Next, the method involves identification of computer resources to be subject to behavior-based access control, as shown at 306. As described above, this may be performed by the RSM 260, and may be performed according to a user's selection of a particular computer resources (such as a particular app), or may be done automatedly/programmatically, including randomly, or according to predetermined logic. If this identification is being done by the software/system, then the software/system automatedly selects a particular computer resources to be subject to behavior-based access control, as shown at 308 and 310. Alternatively, if this identification is not being done by the software/system, then the software/system receives a user's selection/specification of a particular computer resource to be subjected to behavior-based access control, as shown at 208 and 312. For example, the particular resource to be subjected to behavior-based access control may vary over time, and may be, for example, a particular software application/app.

The method then involves receiving a request to access a computer resource. The AMM 270 may determine whether the request is a request to access the particular resource to be subject to behavior-based access control.

In one embodiment, when a request to access the particular computer resource to be subject to behavior-based access control is received, the AMM 270 may then cause display of a graphical user interface window prompting the user to provide input via the appropriate sensor device, as shown at 314 and 316. This may involve determining which sensor is appropriate for the user, behavior objective, etc., and causing prompts to be displayed at the Computing Device 90a, 90b, for gathering appropriate data via the sensor. This may be performed by, or at least in part by, the SM 290 in conjunction with the AMM 270.

The AMM 270 then compares the behavior data gathered via the sensor device to reference data, as shown at 318. This may involve retrieval of suitable Reference Data 224f for the relevant sensor and/or User Data 224a for the relevant user from the data store 224. The AMM 270 then compares the gathered data and the reference data and determines whether the comparison indicates the desired behavior in view of the behavior modification objective, as shown at 320. For example, for a smoking cessation or alcohol cessation goal, this may involve a sensor reading less than a threshold value for the device, and for a weight loss goal, for example, this may involve a sensor reading less than a threshold value for the user.

If it is determined that the comparison indicates that the user's behavior is consistent with desired behavior according to the behavior modification objective (e.g., no detection of alcohol in a breath sample), then access to the access-controlled computer resource is permitted, as shown at 320 and 322, and the method ends, as shown at 324. For example, if permitted, the user may be granted access to use his/her favorite smartphone app because it has been confirmed that the user's behavior has been consistent with the behavior modification objective. The user may then use the controlled computer resource in the desired fashion. This may continue for unlimited or for a limited time, e.g., the duration of a current session, or a particular timeframe. If however, it is determined that the user's behavior is not consistent with desired behavior according to the behavior modification objective (e.g., alcohol was detected in a breath sample), then access to the access-controlled computer resource is denied, as shown at 320 and 326, and the method ends, as shown at 324. In this case, for example, if denied, the user's attempt to open an app or otherwise be granted access to a desired computer resource will not be effective to gain access to/use that computer resource.

In certain embodiments, tokens may be earned and exchanged to unblock access to the app(s)/computer resources, contingent upon objective evidence (provided by hardware sensors or other mechanisms) of goal achievement, such as smoking abstinence (carbon monoxide [CO] <4 ppm). Such an alternative exemplary embodiment is discussed below with reference to FIGS. 4-9. For example, the user interface may be configured to permit users to earn and accumulate tokens for gaining access to/using a computer resource, e.g., by providing suitable breath samples or otherwise providing data via the sensor device and then to permit the user to “spend” or cash in/redeem those tokens in exchange for a period of access to the computer resources. In some such embodiments, there may be prompts to provide samples via a sensor, etc. at times other than in response to a request for access to a computer resource. In one embodiment, when a user sustains abstinence (either with or without the earning of tokens) the user is able to remove apps/computer resources from the list of those that are or can be blocked, but only so long as the user maintains abstinence—if the user relapses or misses submission of a sample via the sensor, the app may return to the list of blocked and/or conditional-access apps until another sustained period of abstinence is achieved.

FIG. 4 is a flow diagram 400 illustrating an exemplary method for sensor-verified earning of tokens as part of behavior-based access control management for a computer resource of computing devices in accordance with an alternative exemplary embodiment of the present invention. Referring now to FIG. 4, the exemplary method begins with determination of whether it is time to gather behavior data, as shown at 402. If not, flow returns to 402 until it is time to gather behavior data. This determination may be made by comparing a current time/date to a prescribed schedule, or to an interval since a last gathering of behavior data, or according to any suitable logic according to the particular behavior modification objective. This may be performed by the AMM 270.

When it is determined at 402 that it is time to gather behavior data, in this exemplary embodiment the AMS 200 (e.g., the AMM 270) next identifies the relevant sensor for use by the user to gather the relevant behavior data, as shown at 404. By way of example, this may be performed by the AMM 270 by referring to the stored User Data 224a, or Sensor Type Data 224c.

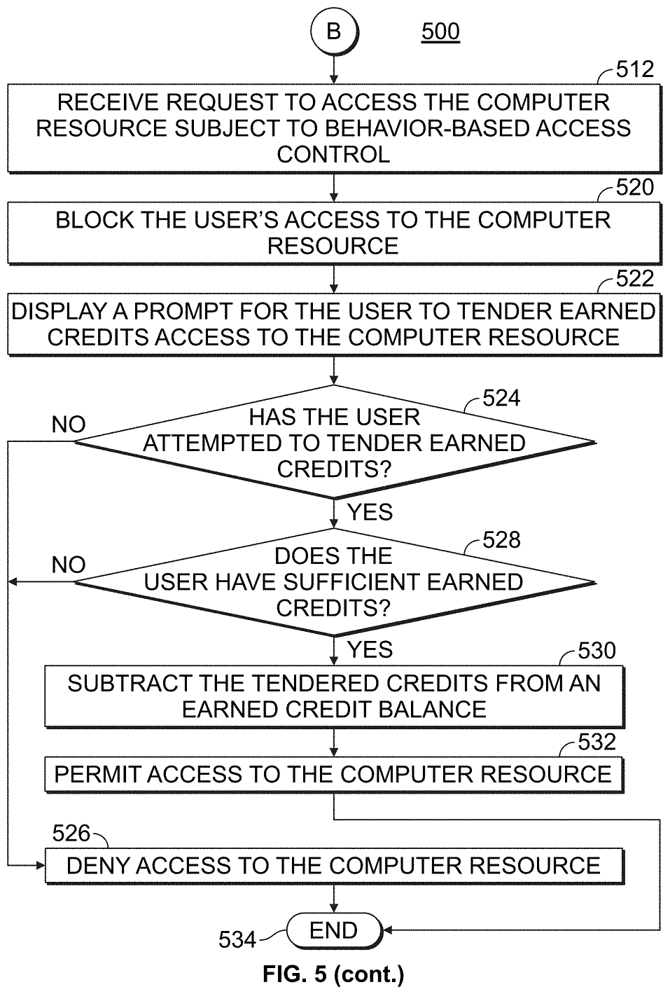

The AMS 200 then displays a prompt to prompt the user to submit behavior data via the sensor, as shown at 406. By way of example, this may be performed by the DM290 acting in concert with the AMM 270 to cause display of a graphical user interface window displaying text or images indicating to the user that it is time to submit behavior data via the sensor. FIG. 7 shows an exemplary graphical user interface window 650 displaying text and graphics prompting the user to submit behavior data via the sensor, which in this example is a carbon monoxide (CO) sensor capable of detecting CO in the user's breath that is indicative of a smoking behavior, as is appropriate in the context of a smoking cessation behavior modification objective.

The user may then provide input (e.g., via touchscreen of the Computing Device 90b) to clear the graphical user interface window containing the prompt (e.g., by clicking the checkmark) and the provide input by selecting the Submit a CO Sample button 630 displayed in the graphical user interface window 600 to initiate a process for submitting a sample (e.g., blowing into a CO sensor 10a operatively connected to the Computing Device 90b) to cause the sensor 10a to gather behavior data (here, CO level data in the breath sample) associated with the sample. Accordingly, the method next involves receiving the behavior data via the sensor device 10a, as shown at 408. This may be performed and/or managed by the Sensor Module 280.

The method then involves retrieval of Reference Data 224f stored in the Data Store 224 for the user and/or the particular sensor device (e.g., CO sensor), as shown at 410. This may be performed by the AMM 270, as described above. For example, the reference data may indicate thresholds for CO level data indicating compliance and/or non-compliance with the behavior modification objective (e.g., smoking cessation).

The method then involves comparing the gathered behavior data from the sensor to the retrieved Reference Data 224f, as shown at 412. This may be performed by the AMM 270, as described above.

If the AMM 270 determines that the comparison does not indicate the desired behavior at 414 (e.g., the gathered data indicates a CO level associated with smoking behavior), then a graphical user interface window may be displayed (e.g., by the AMM 270 acting in concert with the DM 290) to display a message indicating non-compliance with the desired behavior. This data may be stored in association with the user in the User Data 224a of the Data Store 224 for future reference, graphing, etc., and method flow may return to 402 until the next occurrence of a time to gather behavior data/submit a behavior-related sample to a relevant sensor.

If, however, the AMM 270 determines that the comparison does indicate the desired behavior at 414 (e.g., the gathered data indicates a CO level associated with non-smoking behavior), then the user will be rewarded by increasing a balance of earned tokens available for use to “purchase” access to a computer resource subject to behavior-based access control in accordance with the present invention. The increase maybe applied according to any suitable logic. The increase maybe applied by the AMM 270, and data associated with the current balance may be stored in association with the user in the User Data 224a of the Data Store 224 for future reference, graphing, etc. The current balance of tokens may be displayed in the Token Balance panel 640 by the DM 290 (which may reference the current balance stored as User Data 224a in the Data Store 224), as shown in FIG. 7. Tokens of the token balance may be applied by the user to “purchase” access to computer resource subject to a behavior-based access control when the user wishes to access that resource.

The window may be displayed on the user's Computing Device, such as window 600 displayed on Mobile Computing Device 90b in the example shown in FIG. 6. As described above, this may be performed by the BOM 240, and may involve causing display (by transmission of data via the network 50 by the AMS 200, or by software resident at the Computing Device 90a, 90b) at the computing Device 90a, 90b of a graphical user interface allowing a user to select a behavior modification objective from a displayed list of behavior modification objectives.

Referring now to FIG. 5, a flow diagram 500 illustrating an exemplary method for token-based behavior-based access control management for a computer resource in accordance with an alternative exemplary embodiment of the present invention is shown. In this exemplary method, 502-508 and 510 are similar to 302-208 and 310 of FIG. 3, described above. In this exemplary embodiment, the RSM 260 is configured to identify a set of most-frequently used computer resources, e.g., apps, that are candidates for behavior-based access controls, as shown at 514, and the DM 290 (acting in concert with the RSM 260) displays a list of the more frequently used computer resources in the set via a display device of the user's Computing Device, as shown at 516. This allow the RSM 260 to exclude low-priority, infrequently-used, apps/computer resources from the list of available choices for behavior-based access control in accordance with the present invention, because such infrequently-used resources would provide only modest incentive for the behavior modification purposes described herein. Further, the RSM 260/DM 290 permits the user to select from the displayed list (by providing input to the computing device) a specific computer resource (or multiple computer resources) to which the gatekeeper/conditional access functionality will be applied, so that the user's selected computer resource will be subjected to the behavior-based conditional access controls. Accordingly, the method next involves receipt (e.g., by the RSM 260) of the user's selection of a computer resources to be subject to access-based control, as shown at 518. This provides the user with a measure of control over how the user wants to be incentivized.

The method then proceeds to 512, which is described above with reference to 312 of FIG. 3. When a user attempts to access a computer resource, the AMM 270 may determine whether the resource for which access is attempted is one to which behavior-based access controls apply, as described above. When the AMM 270 receives a request to access a computer resource subject to behavior-based access control (e.g., App. #1 as shown in the example of FIG. 6-9) at 512, then the AMM 270 blocks the user's access to the computer resource, as shown at 520. This may be performed as described above, to prevent the user from gaining access to the functionality of the relevant computer resource.

In response to this request (e.g., tapping an app's icon displayed on a touchscreen of a computing device or otherwise initiating access to a computer resource), the DM 290, acting in concert with the AMM 270, displays a prompt for the user to tender tokens in order to gain access the computer resource, as shown at 522.

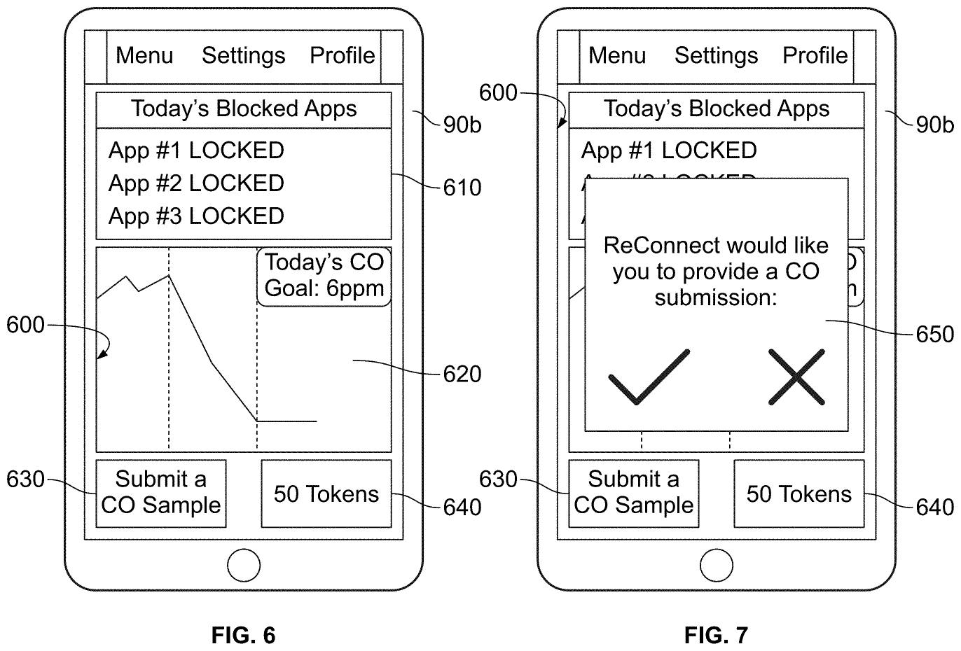

The method then proceeds to 524, where it is determined whether the user has attempted to tender tokens, as shown in FIG. 4. This may be performed by the AMM 270. This may involve or be associated with the DM 290, acting in concert with the AMM 270, displaying a graphical user interface window 660 containing a text and/or images prompting the user to tender/submit tokens from the user's token balance (displayed in panel 640), as shown in FIG. 8. In this example, a token balance of 50 tokens is displayed in 640 (e.g., as the result of the user's earning of tokens by submitting samples to the sensor that indicate behavior compliant with the behavior modification objective), and the prompt displays text prompting the user to tender/submit/apply 10 tokens to access the desired computer resource (App. #1 in this example), as shown in FIG. 8.

If it is determined at 524 that the user has not attempted to tender the tokens (e.g., because the user choose not to “spend” tokens at this time), then the computer resource remains blocked, and thus the user is denied access to the desired computer resource, as shown at 526, and this exemplary instance of the method ends, as shown at 534, although during normal operation all or portions the exemplary methods of FIGS. 4 and 5 (and FIG. 3) will be repeated. Accordingly, the user is thereby denied access to a computer resource that the user wishes to access, which provides an incentive in furtherance of the behavior modification objective, namely, to maintain behavior compliant with the behavior modification objective, earn tokens as a result, and have tokens to apply to “purchase” access to the computer resource that the user wishes to access.

If, however, it is determined at 524 that the user has attempted to tender tokens (e.g. because the user wishes to access the resource at this time), then the system determines whether the user has a sufficient quantity of tokens in the user's token balance, as shown at 528. This may be performed by the AMM 270 with reference to the User Data 224a stored in the Data Store 224, as described above.

If it is determined at 528 that the user does not have a sufficient quantity of tokens in the user's token balance, then the computer resource remains blocked, and thus the user is denied access to the desired computer resource, as shown at 526, and this exemplary instance of the method ends, as shown at 534.

Accordingly, the user is thereby denied access to a computer resource that the user wishes to access, which provides an incentive in furtherance of the behavior modification objective, namely, to maintain behavior compliant with the behavior modification objective, earn tokens as a result, and have tokens to apply to “purchase” access to the computer resource that the user wishes to access.

If, however, it is determined at 528 that the user does have a sufficient quantity of tokens in the user's token balance (as in the example of FIG. 8 where the user has a token balance of 50 tokens and the displayed prompt is requiring 10 tokens), then the AMM 270 subtracts the number of tendered tokens (10) from the current token balance (50) and stores the updated token balance in association with the user as User Data 224a in the Data Store 224, as shown at 530.

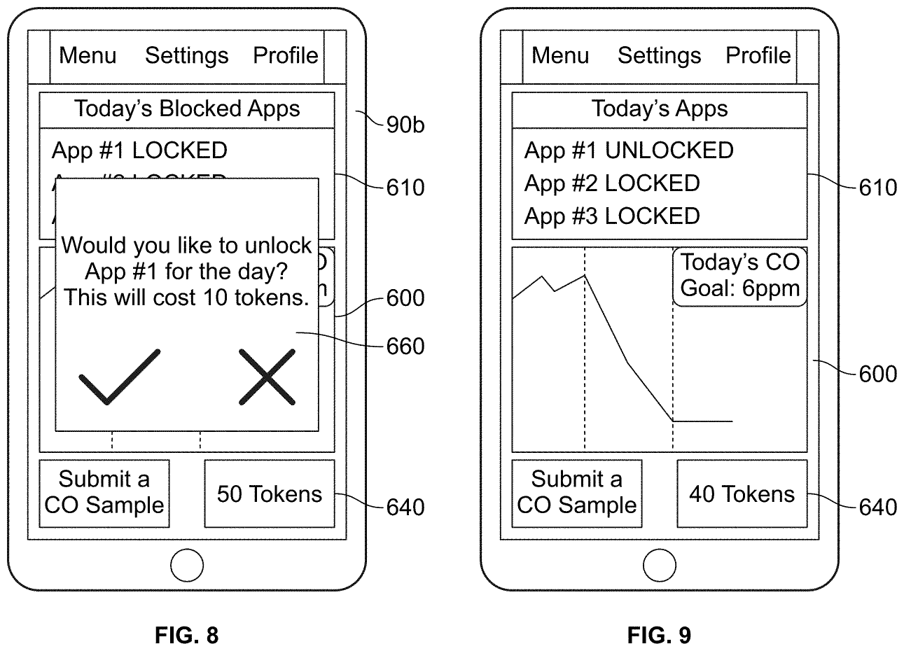

The AMM 270 then permits access to the behavior-based access controlled computer resource, as shown at 532, and the method ends as shown at 534. This may involve the DM 290, acting in concert with the AMM 270, displaying a new updated current token balance (40 tokens) in the Token Balance panel 640, as well as indicating that the resource (e.g., App. #1) now has an unlocked status in Resource Status panel 610, as shown in FIG. 9. Accordingly, actions to access the unlocked resource will result in access to the functionality of the resource. Accordingly, the user is thereby permitted access (typically in a time-limited fashion) to a computer resource that the user wishes to access, which provides an incentive in furtherance of the behavior modification objective, namely, to maintain behavior compliant with the behavior modification objective, earn tokens as a result, and have tokens to apply to “purchase” access to the computer resource that the user wishes to access.

Accordingly, it will be appreciated that the present invention provides a computerized system and method for behavior-based access control management for application software or other resources of computing devices, and to do so by using the user's desire to access those resources as a non-monetary incentive for health-related or other behavior modification, to the benefit of the user.

The various implementations and examples shown above illustrate a method and system for performing a sensor-based access control management for computing device resources. As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an exemplary embodiment, the system may operate as a standalone device or may be connected (e.g., networked) to other machines. In a networked deployment, the system may operate in the capacity of a server or a client system in server-client network environment, or as a peer system in a peer-to-peer (or distributed) network environment. The system may be a server computer, a client computer, a personal computer (PC), a tablet PC, a set-top box (STB), a Personal Digital Assistant (PDA), a cellular telephone, a smart phone, a web appliance, a network router, switch or bridge, or any machine capable of executing a set of instructions (sequential or otherwise) that specify actions to be taken by that system or computing device. Further, while only a single system is illustrated, the term “system” shall also be taken to include any collection of system that individually or jointly execute a set (or multiple sets) of instructions to perform any one or more of the methodologies discussed herein.

The exemplary computer system and client computers include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system and client computing devices also include an alphanumeric input device (e.g., a keyboard or touch-screen), a cursor control device (e.g., a mouse or gestures on a touch-screen), a drive unit, a signal generation device (e.g., a speaker and microphone) and a network interface device.

The system may include a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

What is claimed is:

1. A computer-implemented method for providing behavior-based access control management for computer resources of computing devices via a computerized system having at least one processor and a memory operatively coupled to the memory and storing instructions executable by the processor, the method comprising:
gathering behavior data via a sensor device, the behavior data reflecting an aspect of behavior of a living being;
determining whether the behavior data is consistent with a desired behavior of the living being;
increasing a balance of tokens only if the behavior data is determined to be consistent with the desired behavior;
receiving via said user input device a request to access a computer resource subject to behavior-based access control;
permitting access to the computer resource if the balance of tokens is at least a quantity of tokens required for access to the computer resource, said permitting access to the computer resource comprising display of a graphical user interface window associated with the computer resource via said display device; and
denying access to the computer resource if the balance of tokens is less than a quantity of tokens required for access to the computer resource.

2. The method of claim 1, further comprising:
identifying a computer resource of a computer device to be subject to behavior-based access control.

3. The method of claim 2, wherein said identifying a computer resource of a computer device to be subject to behavior-based access control comprises:
automatedly selecting a selected computer resource from a set of computer resources according to one of a random basis and predetermined logic.

4. The method of claim 2, wherein said identifying a computer resource of a computer device to be subject to behavior-based access control comprises:
identifying a set comprising a plurality of most-frequently used computer resources;
displaying a list identifying the plurality of most-frequently used computer resources in the set via the display device; and
receiving a user's selection of a selected resource selected from the list.

5. The method of claim 1, wherein said receiving via said user input device a request to access a computer resource subject to behavior-based access control comprises:
receiving an access request via said input device input via a graphical user interface window displayed on said display device; and
determining whether said access request is a request to access the computer resource subject to behavior-based access control.

6. The method of claim 1, wherein gathering behavior data via a sensor device, the behavior data reflecting an aspect of behavior of a living being comprises:
determining whether it is time to gather behavior data; and
displaying via said display device a graphical user interface window prompting the living being to provide input via the sensor device.

7. The method of claim 1, further comprising:
identifying a behavior modification objective for a user; and
identifying a suitable sensor device capable of capturing data relevant to the behavior modification objective.

8. The method of claim 1, wherein said determining whether the behavior data is consistent with a desired behavior of the living being comprises:
retrieving reference data stored in the memory, the reference data indicating at least one threshold for behavior data indicative of compliance with the behavior modification objective; and
comparing the gathered behavior data from the sensor device to the retrieved reference data to determine whether it excess said at least one threshold.

9. The method of claim 1, wherein said increasing the balance of tokens only if the behavior data is determined to be consistent with the desired behavior comprises:
displaying via the display device the increased balance of tokens in a graphical user interface window.

10. The method of claim 1, wherein said permitting access to the computer resource if the balance of tokens is at least a quantity of tokens required for access to the computer resource comprises:
decreasing the balance of tokens by the quantity of tokens required for access to the computer resource; and
displaying via the display device the decreased balance of tokens in a graphical user interface window.

11. A computer-implemented system providing behavior-based access control management for computer resources of computing devices, the system comprising:
a display device;
a user input device;
a memory operatively comprising a non-transitory data processor-readable medium;
a data processor operatively connected to the memory, the display and the user input device; and
user interface management instructions embodied in data processor-executable code stored in the memory, said user interface management instructions being executable by the data processor to provide an interface management engine configured to:
gather behavior data via a sensor device, the behavior data reflecting an aspect of behavior of a living being;
determine whether the behavior data is consistent with a desired behavior of the living being;
increase a balance of tokens only if the behavior data is determined to be consistent with the desired behavior;
receive via said user input device a request to access a computer resource subject to behavior-based access control;
permit access to the computer resource if the balance of tokens is at least a quantity of tokens required for access to the computer resource, said permitting access to the computer resource comprising display of a graphical user interface window associated with the computer resource via said display device; and
deny access to the computer resource if the balance of tokens is less than a quantity of tokens required for access to the computer resource.

12. The system of claim 11, said user interface management instructions further comprising instructions executable to provide a user interface management engine configured to:
identify a computer resource of a computer device to be subject to behavior-based access control.

13. The system of claim 12, wherein said user interface management instructions executable to provide a user interface management engine configured to identify a computer resource of a computer device to be subject to behavior-based access control comprises instructions configured to automatedly select a selected computer resource from a set of computer resources according to one of a random basis and predetermined logic.

14. The system of claim 12, wherein said user interface management instructions executable to provide a user interface management engine configured to identify a computer resource of a computer device to be subject to behavior-based access control comprises instructions configured to:
identify a set comprising a plurality of most-frequently used computer resources;
display a list identifying the plurality of most-frequently used computer resources in the set via the display device; and
receive a user's selection of a selected resource selected from the list.

15. The system of claim 11, said user interface management instructions further comprising instructions executable to provide a user interface management engine configured to receive via said user input device a request to access a computer resource subject to behavior-based access control comprises instructions configured to:
receive an access request via said input device input via a graphical user interface window displayed on said display device; and
determine whether said access request is a request to access the computer resource subject to behavior-based access control.

16. The system of claim 11, said user interface management instructions further comprising instructions executable to provide a user interface management engine configured to gather behavior data via a sensor device, the behavior data reflecting an aspect of behavior of a living being comprises instructions to:
determine whether it is time to gather behavior data; and
display via said display device a graphical user interface window prompting the living being to provide input via the sensor device.

17. The system of claim 11, said user interface management instructions further comprising instructions executable to provide a user interface management engine configured to:
identify a behavior modification objective for a user; and
identify a suitable sensor device capable of capturing data relevant to the behavior modification objective.

18. The system of claim 11, said user interface management instructions further comprising instructions executable to provide a user interface management engine configured to determine whether the behavior data is consistent with a desired behavior of the living being comprises instructions to:
retrieve reference data stored in the memory, the reference data indicating at least one threshold for behavior data indicative of compliance with the behavior modification objective; and
compare the gathered behavior data from the sensor device to the retrieved reference data to determine whether it excess said at least one threshold.

19. The system of claim 11, said user interface management instructions further comprising instructions executable to provide a user interface management engine configured to increase the balance of tokens only if the behavior data is determined to be consistent with the desired behavior comprises instructions to:
display via the display device the increased balance of tokens in a graphical user interface window.

20. The system of claim 11, said user interface management instructions further comprising instructions executable to permit access to the computer resource if the balance of tokens is at least a quantity of tokens required for access to the computer resource comprises instructions to:
decrease the balance of tokens by the quantity of tokens required for access to the computer resource; and
display via the display device the decreased balance of tokens in a graphical user interface window.

21. A computer-implemented system providing behavior-based access control management for computer resources of computing devices, the system comprising:
a display device;
a user input device;
a memory operatively comprising a non-transitory data processor-readable medium;
a data processor operatively connected to the memory, the display and the user input device; and
user interface management instructions embodied in data processor-executable code stored in the memory, said user interface management instructions being executable by the data processor to provide an interface management engine configured to:
identify a computer resource of a computer device to be subject to behavior-based access control;
gather behavior data via a sensor device, the behavior data reflecting an aspect of behavior of a living being;
determine whether the behavior data is consistent with desired behavior of the human being; and
permit access to the computer resource if the behavior data is determined to be consistent with the desired behavior; and
deny access to the computer resource if the behavior data is determined not to be consistent with the desired behavior.

22. The system of claim 21, said user interface management instructions further comprising instructions executable to provide a user interface management engine configured to gather behavior data via a sensor device, the behavior data reflecting an aspect of behavior of the living being comprises instructions to display via said display device a graphical user interface window prompting the living being to provide input via the sensor device.

23. A computer program product for providing behavior-based access control management for computer resources of computing devices, the computer program product comprising a non-transitory computer-readable medium storing executable instructions that, when executed by a processor, cause a computerized system to perform a method for providing behavior-based access control management for computer resources of computing devices, the method comprising:
gathering behavior data via a sensor device, the behavior data reflecting an aspect of behavior of a living being;
determining whether the behavior data is consistent with a desired behavior of the living being;
increasing a balance of tokens only if the behavior data is determined to be consistent with the desired behavior;
receiving via said user input device a request to access a computer resource subject to behavior-based access control;
permitting access to the computer resource if the balance of tokens is at least a quantity of tokens required for access to the computer resource, said permitting access to the computer resource comprising display of a graphical user interface window associated with the computer resource via said display device; and
denying access to the computer resource if the balance of tokens is less than a quantity of tokens required for access to the computer resource.
